(19) United States
(12) Patent Application Publication
(10) Pub. No.: US 2013/0271335 A1
(43) Pub. Date: Oct. 17, 2013

(54) HORN ANTENNA APPARATUS

(71) Applicant: Electronics and Telecommunications Research Institute, (US)

(72) Inventors: Han-Cheol Ryu, Daejeon (KR); Kyoung Hyun Park, Daejeon (KR); Jeong Woo Park, Daejeon (KR); Nam Je Kim, Daejeon (KR); Sang-Pil Han, Daejeon (KR); Hyun Sung Ko, Seoul (KR)

(73) Assignee: Electronics and Telecommunications Research Institute, Daejeon (KR)

(21) Appl. No.: 13/856,714

(22) Filed: Apr. 4, 2013

(30) Foreign Application Priority Data
Apr. 12, 2012 (KR) 10-2012-0038152

(51) Int. Cl. H01Q 13/02

(52) U.S. Cl. CPC H01Q 13/02
USPC 343/786

(57) ABSTRACT

Disclosed is a horn antenna apparatus. The horn antenna apparatus includes a substrate; and a silicone antenna part bonded to the substrate and provided with a horn cavity having a radiating aperture part having one portion opened to the outside in a horizontal direction to a bonding surface. In accordance with the embodiment of the present invention, it is possible to easily implement the horn antenna apparatus capable of saving cost and providing the high gain using the photolithography and chemical etching method and to implement the terahertz transmitting and receiving module capable of saving cost and providing the high efficiency using the same.

### CROSS-REFERENCES TO RELATED APPLICATIONS

The present application claims priority under 35 U.S.C 119(a) to Korean Application No. 10-2012-0038152, filed on Apr., 12, 2012, in the Korean Intellectual Property Office, which is incorporated herein by reference in its entirety set forth in full.

### BACKGROUND

Exemplary embodiments of the present invention relate to a horn antenna apparatus, and more particularly, to a horn antenna apparatus capable of transmitting and receiving a signal of a terahertz band using an anisotropy etching characteristic according to a silicone crystal direction.

Recently, with the development of an information communication and image technology, an amount of information to be processed and machined per unit time is remarkably increased due to the addition of image information to voice and character information. As a result, a demand for fast/broadband wireless communications has been increased. However, frequency resources that can be allocated by a country are restricted and therefore, it is possible to realize a fast/broadband wireless communication technology.

Therefore, in order to solve the above problems, research into a broadband communication system using a microwave band, a millimeterwave band, and a terahertz band has been actively conducted.

In particular, since an electromagnetic wave in a terahertz (THz) band of 100 GHz to 10 THz may transmit non-metal and non-polar materials and a resonance frequency of very various molecules may be distributed in the band, it is expected to provide a new concept analysis technology in very various fields such as medical, agriculture, foods, environment measurement, bio, safety, advanced material evaluation, and the like.

In addition, a signal in a terahertz (THz) band little affects a human body due to very low energy of several [meV] levels and therefore, has been rapidly grown as a fundamental technology of realizing a human centered Ubiquitous society.

An antenna used to transmit and receive a signal in a terahertz band may be configured of a flat type antenna formed on a semiconductor substrate and a hemispherical silicone lens attached to a rear surface of a substrate or may be configured of a waveguide type horn antenna.

However, when using the flat type antenna and the lens, a radio wave generated from a photoconductor transmits the substrate and the lens forming the flat type antenna and is propagated to a free space. Therefore, many losses may occur in this process and it is different to accurately align and attach the lens to a rear surface of the substrate on which the antenna is formed.

Meanwhile, the waveguide type horn antenna that is another type of the terahertz band antenna is configured to match the system with the waveguide horn antenna, such that the system may be large and expensive.

As the related art, US Patent Laid-Open No. 2010-0033709 (Publication on Feb. 11, 2010, Title of the Invention: Integrated Terahertz Antenna and Transmitter and/or Receiver, and A Method of Fabricating Them).

The above-mentioned technical configuration is a background art for helping understanding of the present invention and does not mean related arts well known in a technical field to which the present invention pertains.

### SUMMARY

An embodiment of the present invention is directed to a horn antenna apparatus capable of saving cost and providing high gain and transmission efficiency using an anisotropy etching characteristic of silicone.

An embodiment of the present invention relates to a horn antenna apparatus, including: a substrate; and a silicone antenna part bonded to the substrate and provided with a horn cavity having a radiating aperture part having one portion opened to the outside in a horizontal direction to a bonding surface.

In the silicone antenna part, metal may be deposited on an etching surface of the horn cavity formed on a silicone substrate.

The horn cavity may be formed to have a cross sectional area of the horn cavity reduced toward an opposite side of the radiating aperture part.

A section of the horn cavity may be an isosceles trapezoid.

The silicone substrate may be a bulk silicone.

A section of the horn cavity may be a triangle.

The silicon antenna part may be implemented as any one of a platform for a terahertz transmitter heterogeneously coupled with a terahertz transmitting and receiving device, a platform for a terahertz receiver, and a platform for a terahertz transceiver.

The terahertz transmitting and receiving device may include at least one of a terahertz generator, a duplexer, and a terahertz detector.

Another embodiment of the present invention relates to a horn antenna apparatus, including: a first bulk silicone; and a second bulk silicone bonded with the first bulk silicone, wherein a mutual bonding surface of the first bulk silicone and the second bulk silicone is provided with a horn cavity having a radiating aperture part having one portion opened to the outside in a horizontal direction to the mutual bonding surface.

The horn cavity may be formed to have a cross sectional area of the horn cavity reduced toward an opposite side of the radiating aperture part.

The horn cavity may be formed to have a symmetrical structure based on the bonding surface.

A section of the horn cavity may be a quadrangle.

The horn antenna apparatus may further include a feeding part disposed on the mutual bonding surface to feed a signal.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram for describing an anisotropy etching characteristic according to a silicone crystal direction;

FIG. 2 is an exemplified diagram of a configuration of a horn antenna apparatus in accordance with an embodiment of the present invention as a sectoral horn antenna in which a section of a horn cavity is an isosceles trapezoid;

FIG. 3 is a diagram for describing a horn antenna structure of FIG. 2;

FIG. 4 is an exemplified diagram of a configuration of a horn antenna apparatus in accordance with an embodiment of the present invention as a pyramidal horn antenna in which a section of a horn cavity is a triangle;

FIG. 5 is an exemplified diagram of a configuration of a horn antenna apparatus in accordance with an embodiment of the present invention as a pyramidal horn antenna in which a section of a horn cavity is a quadrangle (diamond);

FIG. 6 is a diagram for describing the horn antenna structure of FIGS. 4 and 5;

FIG. 7 is a first exemplified diagram schematically illustrating a terahertz transceiver including the horn antenna apparatus in accordance with the embodiment of the present invention; and

FIG. 8 is a second exemplified diagram schematically illustrating a terahertz transceiver including the horn antenna apparatus in accordance with the embodiment of the present invention.

### DESCRIPTION OF SPECIFIC EMBODIMENTS

Hereinafter, a horn antenna apparatus in accordance with embodiments of the present invention will be described in detail with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

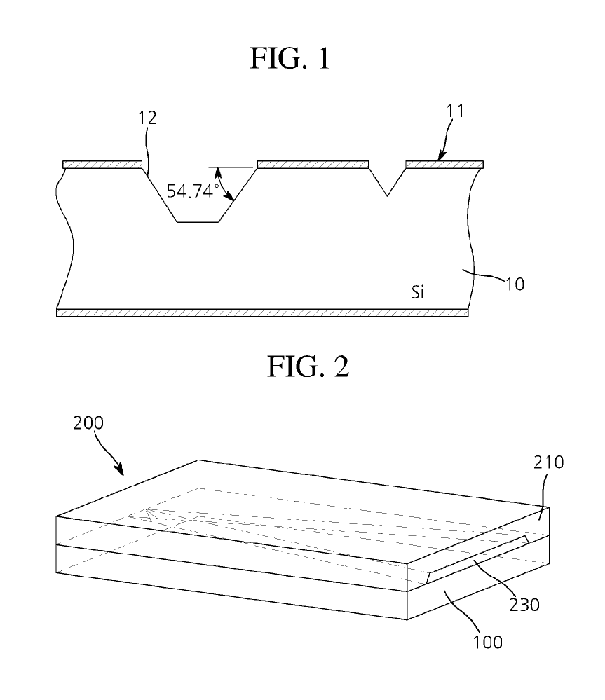

FIG. 1 is a diagram for describing an anisotropy etching characteristic according to a silicone crystal direction.

An embodiment of the present invention is to provide a horn antenna apparatus capable of saving cost and providing high gain and high transmission efficiency using an anisotropy etching characteristic according to a silicone crystal direction.

Here, the anisotropy characteristic means characteristics having physical properties of an object changed according to a direction. As illustrated in FIG. 1, a top surface 11 and an etching surface 12 of a silicone 10 on which a SiO₂ mask is formed are etched to have an angle of 54.74°, such that the silicone 10 has the anisotropy etching characteristic.

That is, the silicone 10 may be etched to have the anisotropy characteristic using a photolithography of applying a photoresist solution to a surface of the silicone 10 and transferring a pattern of a photomask to the surface of the silicone and a wet etching method based on chemical etching. The photolithography and the wet etching method are known to those skilled in the art and therefore, a detailed description thereof will be omitted.

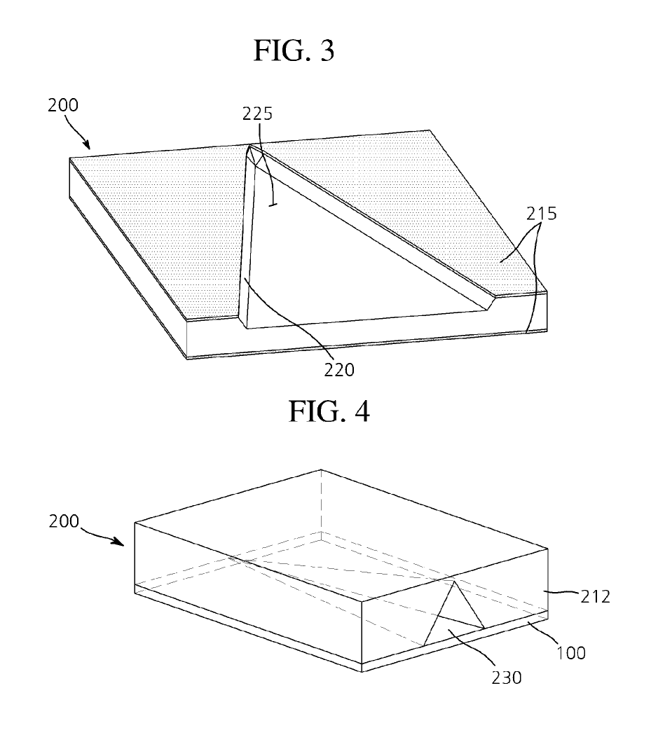

FIG. 2 is an exemplified diagram of a configuration of a horn antenna apparatus in accordance with an embodiment of the present invention as a sectoral horn antenna in which a section of a horn cavity is an isosceles trapezoid and FIG. 3 is a diagram for describing a horn antenna structure of FIG. 2.

As illustrated in FIGS. 2 and 3, the horn antenna apparatus in accordance with the embodiment of the present invention includes a substrate 100 and a silicone antenna part 200.

The substrate 100 means a generally used substrate and may be provided with a feeding part (not illustrated) for feeding a signal of a terahertz band or a terahertz transmitting and receiving module (not illustrated) for transmitting and receiving a signal of a terahertz band.

The silicone antenna part 200 is bonded to the substrate 100 and is provided with a horn cavity 225 having one portion opened to the outside in a horizontal direction to a bonding surface according to the etching of a surface bonded to the substrate 100.

The horn cavity 225 means a kind of empty space formed by the etching and a signal emitted from an etching surface to be described below is transmitted to the outside through the horn cavity 225.

The silicone antenna part 200 may include a silicone substrate 210, an etching surface 220, and a radiating aperture part 230.

The etching surface 220 is a surface on which metal is deposited after one portion of the silicone substrate 210 bonded to the surface 100 is etched. Here, the etching surface 220 is etched to have an angle of 54.74° to a surface on which the silicone substrate 210 is bonded to the substrate 100 so that the horn cavity 225 may be formed.

When one portion of the silicone substrate 210 is etched as described above, as illustrated in FIG. 3, the horn cavity 225 is formed between the substrate 100 and the silicone substrate 210 and the signal may be transmitted and received through the horn cavity 225.

In this case, the horn cavity 225 may have the radiating aperture part 230 having one portion opened to the outside and the horn cavity 225 may be formed to have the cross sectional area reduced toward an opposite side of the radiating aperture part 230. That is, the horn cavity 225 may be formed to have an inner space gradually narrow toward an opposite side of the radiating aperture part 230.

For example, as illustrated in FIG. 2, the section of the horn cavity 225 may be formed in an isosceles trapezoid and the horn cavity 225 may be formed to have a cross sectional area toward the opposite side of the radiating aperture 230 so as to be implemented as a sectoral horn antenna.

Referring to FIG. 3, the sectoral horn antenna illustrated in FIG. 2 may be manufactured by forming SiO₂ masks 215 on top and bottom surfaces of the silicone substrate 210, etching the silicone substrate 210 so as to form the horn cavity 225 having a cross sectional area reduced toward the opposite side of the radiating aperture 230, and then, depositing metal on the etching surface 220.

The feeding to the silicone antenna part 200 may be performed by controlling a shape of the cavity 225 and a position of the feeding part formed on the substrate 100.

A length and a section shape and size of the horn cavity 225 can be controlled using the photolithography method and the wet etching method based on the chemical etching, thereby easily controlling a phase error and a gain of the horn antenna apparatus.

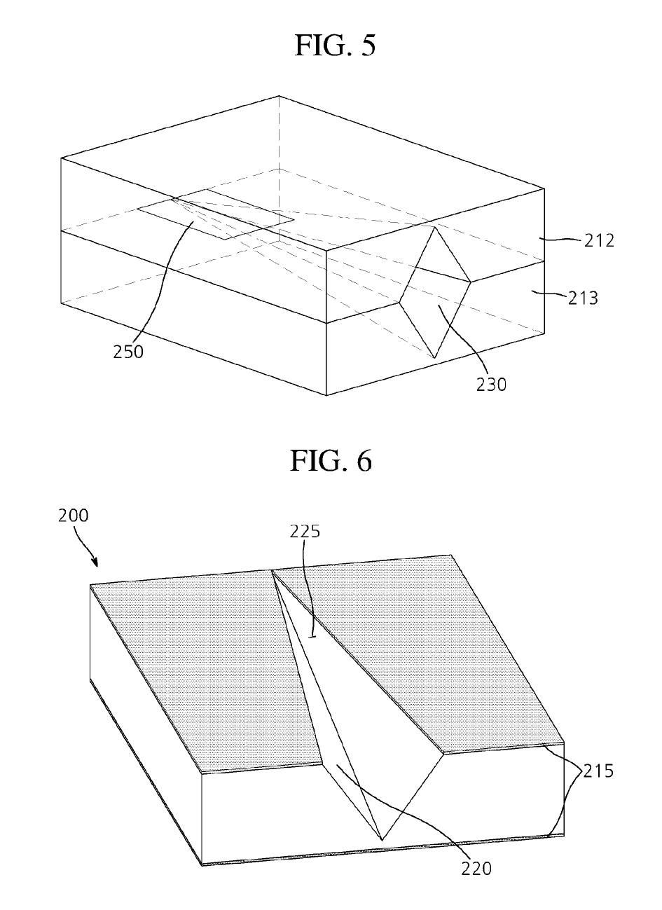

FIG. 4 is an exemplified diagram of a configuration of a horn antenna apparatus in accordance with an embodiment of the present invention as a pyramidal horn antenna in which a section of a horn cavity is a triangle, FIG. 5 is an exemplified diagram of a configuration of a horn antenna apparatus in accordance with an embodiment of the present invention as a pyramidal horn antenna in which a section of a horn cavity is a quadrangle (diamond), and FIG. 6 is a diagram for describing the horn antenna structure of FIGS. 4 and 5.

Meanwhile, although the foregoing embodiments describes, by way of example, the case in which the silicone antenna part 200 is implemented as the sectoral horn antenna of which the section of the radiating aperture part 230 is an isosceles trapezoid, the silicone antenna part 200 may be implemented as a pyramidal horn antenna of which the section of the radiating aperture part 230 is a triangle as illustrated in FIG. 4.

That is, as illustrated in FIG. 4, the silicone substrate 210 of the silicone antenna part 200 may be formed of a bulk silicone 212, wherein a surface on which the bulk silicone 212 is bonded to the substrate 100 may be etched to form the horn cavity 225 having a triangular section.

In this case, the horn cavity 225 may be formed to have the cross sectional area reduced toward the opposite side of the radiating aperture 230 to implement the pyramidal horn antenna of which the section of the horn cavity 225 is a triangle.

Meanwhile, as illustrated in FIG. 5, the horn cavity 25 having the radiating aperture part 230 having one portion opened to the outside may be formed by etching and bonding two bulk silicones 212 and 213.

In this case, the two bulk silicones 212 and 213 may be etched to have a symmetrical structure to each other based on the mutual bonding surface.

Further, the horn cavity 225 formed by the etching and bonding of the two bulk silicones 212 and 213 is formed to have the cross sectional area reduced toward the opposite side of the radiating aperture part 230, thereby implementing the pyramidal horn antenna of which the section of the horn cavity 225 is a quadrangle (diamond).

Meanwhile, the mutual bonding surface of the two bulk silicones 212 and 213 may be provided with the feeding part 250 for feeding a signal to the bonding surface.

Referring to FIG. 6, the pyramidal horn antenna illustrated in FIG. 4 may be manufactured by forming the SiO₂ masks 215 on the top and bottom surfaces of the bulk silicone 212, performing the etching until the radiating aperture part 230 is formed, and then, depositing metal on the etching surface 220.

In this case, the etching speed is very slowly performed from the time when the two etching surfaces 220 meet each other and therefore, the horn cavity 225 is formed in an appropriate shape, such that the pyramidal horn antenna of which the section of the horn cavity 225 is a triangle may be manufactured.

In addition, the etching is performed until the SiO₂ mask 215 is formed on the lower bulk silicone 213, the radiating aperture part 230 having the triangular section is formed, and then, the feeding part 250 may be formed on the top thereof.

Next, the upper bulk silicone 212 is etched by the same method so as to be bonded to the lower bulk silicone 213, such that the pyramidal horn antenna of which the section of the horn cavity is a quadrangle (diamond) as illustrated in FIG. 5 may be manufactured.

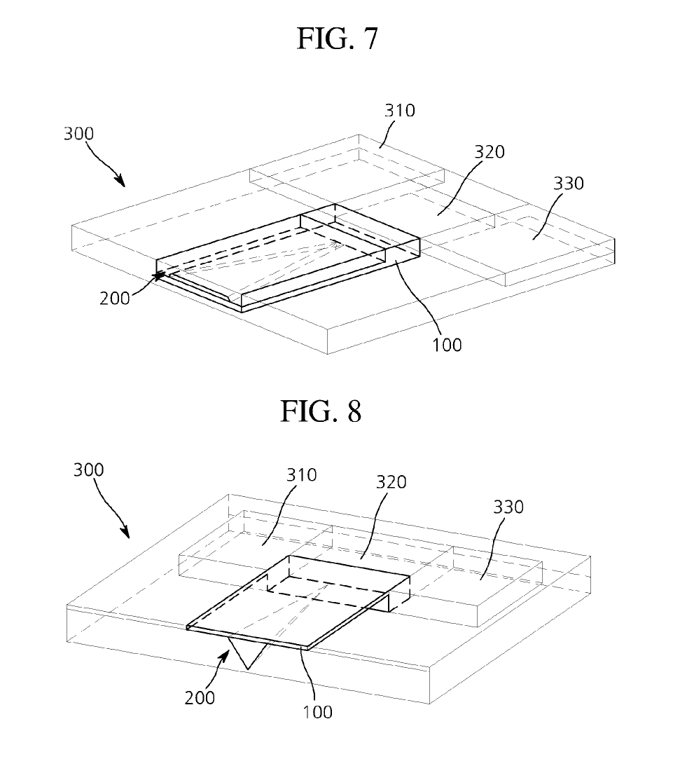

FIG. 7 is a first exemplified diagram schematically illustrating a terahertz transceiver including the horn antenna apparatus in accordance with the embodiment of the present invention and FIG. 8 is a second exemplified diagram schematically illustrating a terahertz transceiver including the horn antenna apparatus in accordance with the embodiment of the present invention.

Meanwhile, FIG. 7 illustrates an example in which the terahertz transceiver is implemented using the sectoral horn antenna illustrated in FIG. 2 and FIG. 8 illustrates an example in which the terahertz transceiver is implemented using the pyramidal horn antenna illustrated in FIG. 4.

A terahertz transceiver 300 includes a terahertz generator 310, a duplexer 320, a terahertz detector 330, and the silicon antenna part 200 in accordance with the embodiment of the present invention.

Here, the terahertz generator 310, the duplexer 320, and the terahertz detector 330 configuring the terahertz transceiver 300 are included in the general terahertz transceiver 300 and the detailed description thereof will be omitted.

Referring to FIG. 7, the terahertz transceiver 300 may be configured to heterogeneously couple the sectoral horn antenna illustrated in FIG. 2 with a semiconductor platform in which the terahertz generator 310, the duplexer 320, and the terahertz detector 330 are included. However, unlike this, the terahertz transceiver 300 can be configured by heterogeneously coupling the pyramidal horn antenna illustrated in FIG. 4 with the semiconductor platform.

In addition, referring to FIG. 8, the terahertz transceiver 300 can be configured by heterogeneously couple the terahertz generator 310, the duplexer 320, and the terahertz detector 330 with a platform for a terahertz transceiver including the silicon antenna part 200.

In this case, the platform for the terahertz transceiver may be implemented as the sectoral horn antenna illustrated in FIG. 2 or the pyramidal horn antenna illustrated in FIG. 4.

Meanwhile, FIG. 8 illustrates, by way of example, the case in which the silicone antenna part 200 is implemented as the platform for the terahertz transceiver heterogeneously coupled with a terahertz transmitting and receiving device, but the silicon antenna part 200 may be implemented as a platform for a terahertz transmitter or a platform for a terahertz receiver. In this configuration, the terahertz transmitting and receiving device may include the terahertz generator 310 or the terahertz detector 320.

According to the horn antenna apparatus in accordance with the embodiment of the present invention, it is possible to implement an expensive horn antenna apparatus capable of transmitting and receiving a signal of the terahertz band with the high gain by using the anisotropy etching characteristic according to the silicone crystal direction.

In addition, when the platform heterogeneously coupled with the terahertz transmitting and receiving device is configured, the terahertz transmitting and receiving module having the high directivity and the high gain may be implemented at low cost and high efficiency.

In this case, the feeding efficiency to the silicone antenna part 200 is very important in the terahertz transmitting and receiving device. To this end, the feeding can be made by forming the radiating aperture part 230 on a ground surface of the terahertz transmitting and receiving device or the feeding can be made by configuring the flat type antenna (not illustrated) of which the radiating pattern has directivity.

Further, in order to increase the feeding efficiency, a ridge is formed on the silicone substrate 210 or the size and the position of the horn cavity 224 formed on the silicone antenna part 200 can be controlled.

In accordance with the embodiments of the present invention, it is possible to easily implement the horn antenna apparatus capable of saving cost and providing the high gain using the photolithography and chemical etching method.

In addition, in accordance with the embodiments of the present invention, it is possible to implement the terahertz transmitting and receiving module capable of saving cost and providing the high efficiency by configuring the terahertz transmitting and receiving platform using the horn antenna apparatus.

Although the embodiments of the present invention have been described in detail, they are only examples. It will be appreciated by those skilled in the art that various modifications and equivalent other embodiments are possible from the present invention. Accordingly, the actual technical protection scope of the present invention must be determined by the spirit of the appended claims.

What is claimed is:

1. A horn antenna apparatus, comprising:
a substrate; and
a silicone antenna part configured to be bonded to the substrate and provided with a horn cavity having a radiating aperture part having one portion opened to the outside in a horizontal direction to a bonding surface.

2. The horn antenna apparatus of claim 1, wherein in the silicone antenna part, metal is deposited on an etching surface of the horn cavity formed on a silicone substrate.

3. The horn antenna apparatus of claim 1, wherein the horn cavity is formed to have a cross sectional area of the horn cavity reduced toward an opposite side of the radiating aperture part.

4. The horn antenna apparatus of claim 3, wherein a section of the horn cavity is an isosceles trapezoid.

5. The horn antenna apparatus of claim 1, wherein the silicone substrate is a bulk silicone.

6. The horn antenna apparatus of claim 5, wherein a section of the horn cavity is a triangle.

7. The horn antenna apparatus of claim 1, wherein the silicon antenna part is implemented as any one of a platform for a terahertz transmitter heterogeneously coupled with a terahertz transmitting and receiving device, a platform for a terahertz receiver, and a platform for a terahertz transceiver.

8. The horn antenna apparatus of claim 7, wherein the terahertz transmitting and receiving device includes at least one of a terahertz generator, a duplexer, and a terahertz detector.

9. A horn antenna apparatus, comprising:
a first bulk silicone; and
a second bulk silicone configured to bonded to the first bulk silicone,
wherein a mutual bonding surface of the first bulk silicone and the second bulk silicone is provided with a horn cavity having a radiating aperture part having one portion opened to the outside in a horizontal direction to the mutual bonding surface.

10. The horn antenna apparatus of claim 7, wherein the horn cavity is formed to have a cross sectional area of the horn cavity reduced toward an opposite side of the radiating aperture part.

11. The horn antenna apparatus of claim 7, wherein the horn cavity is formed to have a symmetrical structure based on the bonding surface.

12. The horn antenna apparatus of claim 7, wherein a section of the radiating aperture part is a quadrangle.

13. The horn antenna apparatus of claim 7, further comprising: a feeding part configured to be disposed on the mutual bonding surface to feed a signal.
